(19) United States
(12) Patent Application Publication
(10) Pub. No.: US 2011/0218993 A1
(43) Pub. Date: Sep. 8, 2011

(54) SEMANTIC PAGE ANALYSIS FOR PRIORITIZING CONCEPTS

(75) Inventors: Erik Van Mulligen, Rotterdam (NL); Ravi Kalaputapu, Rockville, MD (US); Marc Weeber, Groningen (NL)

(73) Assignee: Knewco, Inc., Gaithersburg, MD (US)

(21) Appl. No.: 13/039,298

(22) Filed: Mar. 2, 2011

Related U.S. Application Data
(60) Provisional application No. 61/309,549, filed on Mar. 2, 2010.

(51) Int. Cl. G06F 17/30

(52) U.S. Cl. 707/728; 707/E17.014

(57) ABSTRACT

Embodiments disclose a method of obtaining relevancy scores for concepts found on a page of content. Methods disclosed rely on connectivity of concepts found in a page in relation to connectivity of the same concepts with other concepts in general, and the semantic relationships between the concepts found on a page to obtain relevancy of concepts.

### CROSS-REFERENCE TO RELATED APPLICATION

This application claims the benefit of U.S. provisional application No. 61/309,549 filed on Mar. 2, 2010, the complete disclosure of which, in its entirety, is herein incorporated by reference.

### TECHNICAL FIELD

The embodiments herein relate to information retrieval and information extraction and, more particularly but not exclusively, to concept selection mechanism in the process of information retrieval and information extraction.

### BACKGROUND

Internet has become an increasingly accessible means to search content on the web. Web based content searching forms a large swath of today's Internet ecosystem. One of the main means for extraction of information is based on contextual analysis of the search query. Some mechanisms employ means for generation of keywords, synonyms and the like for obtaining search results. Also, some approaches employ relevance listing based on co-occurrence of the same words or synonyms for the word within the web page. However, such mechanisms for extracting search results based solely on words or phrases found within the text of the web page can lead to erroneous results.

In an example, in generating contextual information for an input query the search engines extract information from each and every web page of a website. Every bit of information extracted is indexed and stored in the database maintained by the search engine. A list of keywords is obtained and stored from the indexed information. When a user enters a search query, the search query is compared against the indexed information and a list of relevant search results is obtained. During the comparison process, the search query entered by the user is compared against list of keywords to obtain the results. In such mechanisms, a hard match is required between the query entered by the user with one of the keywords or key phrases stored in the database. Hence, website owners that submit their web page to such search service have to find the set of keywords that best fit the submitted web page. The same holds true when a user submits a search query with a spelling mistake, a partial query (which consists of a sub-string of the indexed key terms), and a query in which the words do not appear in the same order as is in the indexed key terms and so on. In all such cases, the search service may not provide the user with appropriate search results to the submitted query. As a result, such mechanisms are not effective in extracting effective results for search query input by the user.

Some other search systems employ a method wherein the query entered by the user is mapped to obtain closeness in the “meaning” for the search query. Further, information that is closest in “meaning” is returned in the search results. One significant drawback of this method is that obtaining “meaning” is relatively vague and not easily determined. These search engines provide limited functionality and also do not recognize keywords in the query that are beyond the exact matches produced by the matching process.

In a US provisional application titled “Related Concept Selection using Semantic and Contextual Relationships”, Kalaputapu et al address the aforementioned drawbacks of existing systems, and disclose methods and systems for concept selection and ranking using input information obtained. The input information may include keywords, web page content and the like. Such ranked and selected concepts may be used in various applications like searching, advertising, highlighting relevant concepts on a web page among others.

Selecting relevant concept(s) on a web page involves analyzing the content of the page. Existing systems that attempt concept selection on a page do selection of concepts based on frequency of concepts appearing on a page. In a simplistic scenario, the concept that appears more frequently will be given preference over other concepts that appear relatively less frequently. Selection of concepts on a page based on measures that rely on frequency of appearance of concepts may result in sub optimal selection.

### BRIEF DESCRIPTION OF THE FIGURES

The embodiments herein will be better understood from the following detailed description with reference to the drawings, in which:

FIG. 1 illustrates relations between concepts found on a page according to embodiments herein;

FIG. 2 illustrates a method of semantic page analysis for concept selection according to embodiments herein;

FIG. 3 illustrates an example environment in which semantic page analysis methods disclosed herein may be applied;

FIG. 4 illustrates a method according to which semantic page analysis may be used in an example environment;

FIG. 5 illustrates an example environment in which semantic page analysis methods disclosed herein may be applied; and

FIG. 6 illustrates a method according to which semantic page analysis may be used in an example environment.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

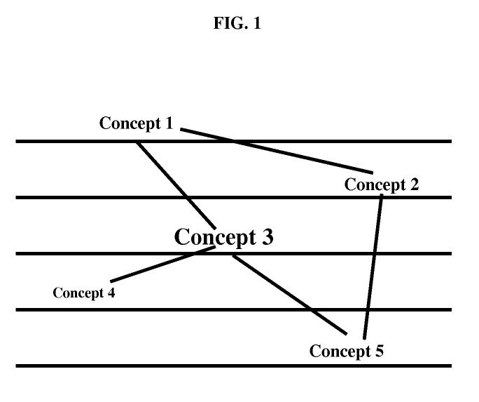

The embodiments herein disclose page analysis methods for concept selection using semantic relationships. Referring now to the drawings, and more particularly to FIGS. 1 through 6, where similar reference characters denote corresponding features consistently throughout the figures, there are shown embodiments.

FIG. 1 illustrates relationships between concepts found on a page according to embodiments herein. Indexing of text on a page, finding concepts on a page, assigning semantic relationship values to different types of relations between concepts, and creation of concept relation database have been discussed in detail by Albert Mons et al. in their US patent application 20080301174 titled “Data structure, system and method for knowledge navigation and discovery”. The page may be any source of information such as a web page or any other repository of information. Two basic types of concepts are defined: (a) a source concept, corresponding to a query; and (b) a target concept, corresponding to a concept having some relationship with the source concept. Each concept, identified by its unique identifier, is assigned minimally three attributes: (1) factual; (2) co-occurrence; and (3) associative values.

The factual attribute of a concept relationship is an indication of whether the concept has been mentioned in authoritative databases (i.e., databases or other repositories of data that have been deemed authoritative by the scientific community in a given area of science and/or other area of human endeavor). For example, a relationship between a “drug” and a “disease” may be described as “drug treats a disease” and such a relationship based on factual attribute may be broadly understood as a concept having a sibling concept.

The co-occurrence attribute is an indication of whether the source concept has been mentioned together with the target concept in a unit of text (e.g., in the same sentence, in the same paragraph, in the same abstract, etc.) within a database or other data store or repository that have not been deemed authoritative.

The associative attribute is an indication of conceptual overlap between the two concepts. For example, two concepts may be predicted to have an associative relationship if the two concepts share a set of related concepts.

For each type of relationship found between concepts, a semantic relationship value is assigned. These values (or weights) may be part of a lookup table in the concept relation database or may exist as a separate lookup table.

Traditionally, selection of relevant concepts on a page has been largely based on frequency of appearance of concepts. However, such an approach may lead to sub optimal results in selecting relevant concepts in a page. Embodiments herein disclose methods for selecting relevant concepts, where the methods rely on connectivity of concepts found in a page in relation to connectivity of the same concepts with other concepts in general, and the semantic relationships between the concepts found on a page. An ordinary skilled person in the art would appreciate that while concepts as defined using data structures and methods disclosed by Albert Mons et al in their US patent application 20080301174 may be used in the methods and systems described here, such definitions are not to be construed as limitations of embodiments disclosed herein. In fact, as an example, any externally available information/knowledge encoded as an RDF triplet (concept-relation-concept) may be used to find relevant concepts (defined entirely differently as opposed to definitions used by Albert Mons et al.) on a page in accordance with embodiments herein.

According to embodiments herein, as illustrated in FIG. 1, concepts that have more relationships (or more connectivity) on a page with other concepts as identified through a concept relation database have a relatively higher relevancy to the content of the page. Further, relevancy of a concept with respect to the content of page is also determined by the type of relationships the concept has with other concepts found on the page.

### Concept Selection

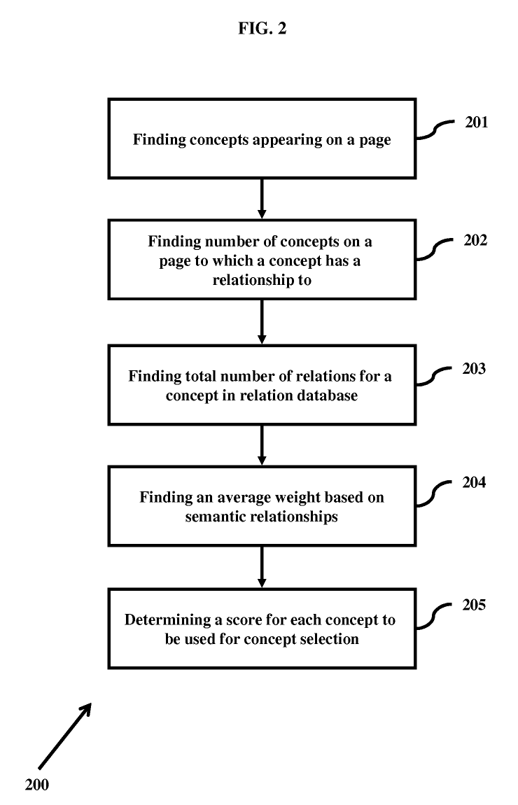

FIG. 2 illustrates a method of semantic page analysis for concept selection according to an embodiment herein. The method involves finding (201) the concepts appearing on a page. Once the concepts are found, for each concept, the number of concepts that the concept is related to on the page is found (202). Further, for each concept, the number of concepts that the concept is related to in the concept relationship database is determined (203). Furthermore, for each concept, an average weight of its relations with other concepts is determined (204) based on weights for each type of relation and the weights obtained for its neighbors. The weights for each relationship type may be obtained from a lookup table that comprises of weights for each semantic relationship type. The aforementioned findings are then used to determine (205) a score of relevancy for each concept found on the page. The various actions in method 200 may be performed in the order presented, in a different order or simultaneously. Further, in some embodiments, some actions listed in FIG. 2 may be omitted.

The semantic relevancy (r) of a concept (K) to the content of a page, determined as illustrated by FIG. 2, may be given by

r=((C/R)*W)+(D*avg(r(neighbors))),

where

C=Connectivity of K, i.e. the number of concepts on a page to which a concept has a relationship to,

R=total number of relations for K in the relation databases, and

W=weighting of relations for K on basis of their type.

D=constant for weighting neighbor weights, where neighbors are concepts related to a source concept

For example, if K has three relations on a page and the weights for the semantic relationship types for those relations as obtained from the look up table are w1, w2 and w3. The W may be determined as follows:

W=(w1+w2+w3)/3

### Example Environments

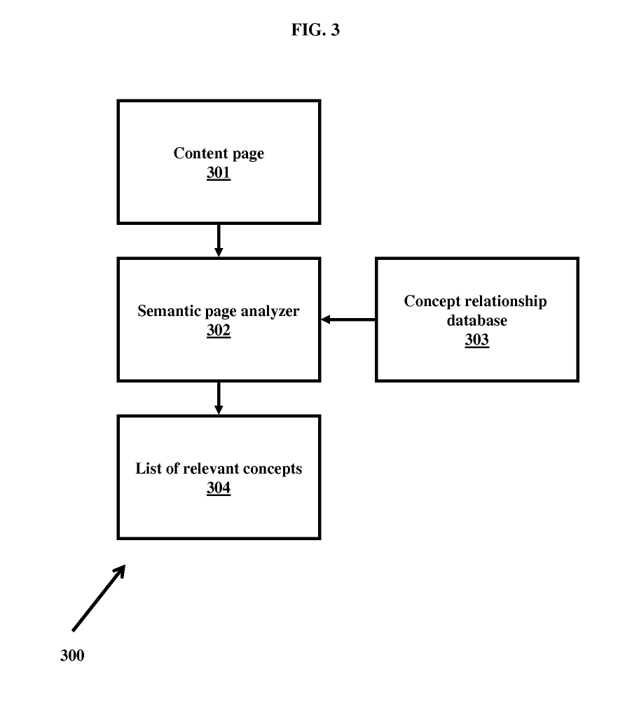

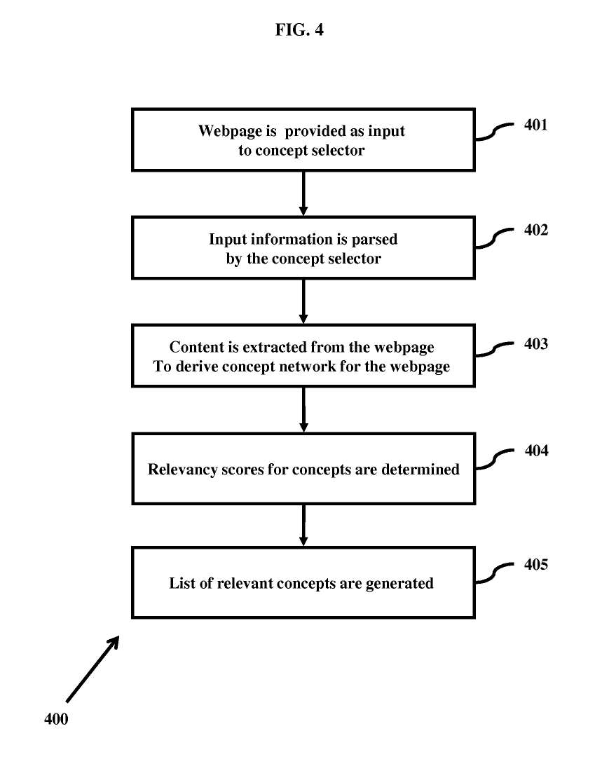

FIG. 3 shows an example environment in which the aforementioned method of concept selection is used in a concept selector 300. FIG. 4 illustrates the process of obtaining relevant concepts according to the embodiment illustrated in FIG. 3. The aforementioned concept scoring method may be embodied in a semantic page analyzer module 302. The semantic page analyzer 302 gets (401) the content of a page 301 as input. The semantic page analyzer 302 parses (402) the text of the content, indexes the text of the content, obtains (403) the concepts, and concept network. Further, the semantic page analyzer 302 assigns (404) relevancy scores to the concepts. The semantic page analyzer may use the concept relation database 303 to obtain information including but not limited to the number of other concepts a concept is related to, and the weight values assigned for various semantic relationship types. Using the relevancy scores determined for the concepts identified in the content 301, semantic page analyzer 302 generates (405) a list of relevant concepts 304 that may be sorted according to the relevancy score.

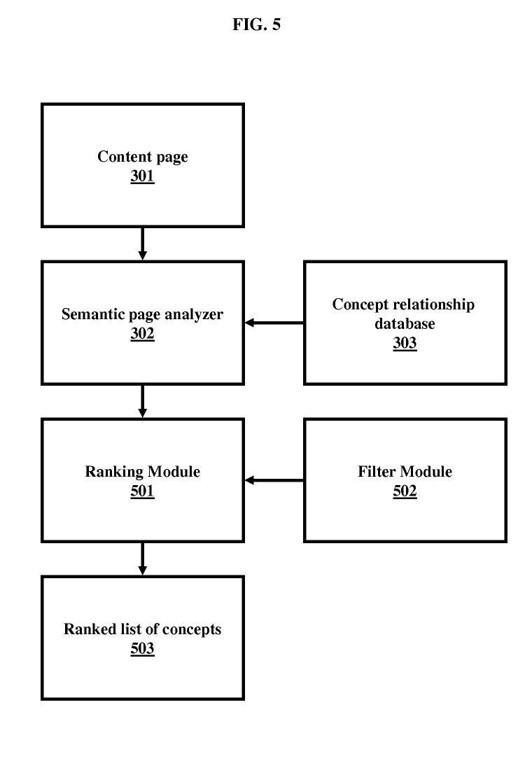

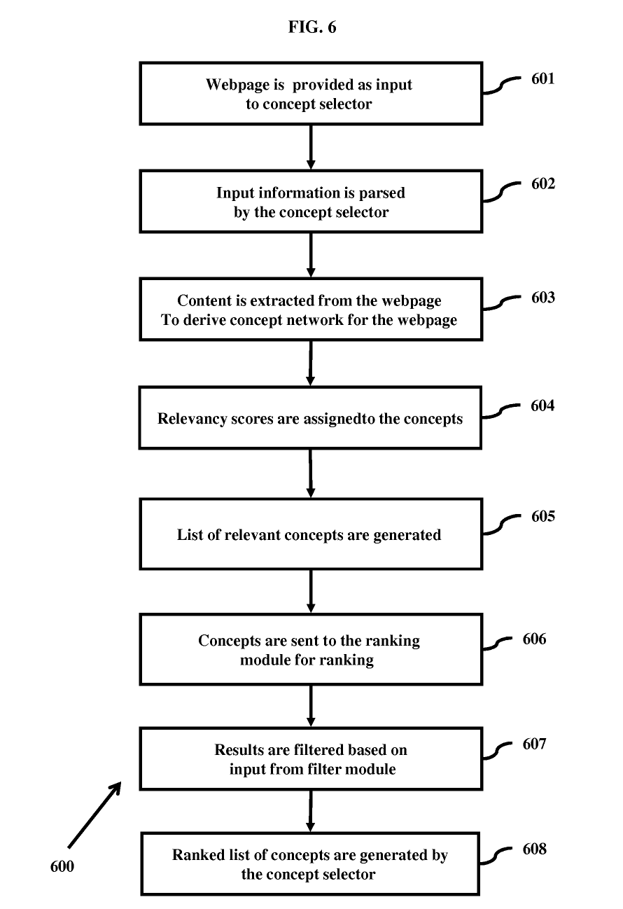

FIG. 5 shows an example environment in which the aforementioned method of concept selection is used in a concept selector 300 with further ranking of concepts. FIG. 6 illustrates the process of obtaining relevant concepts according to the embodiment illustrated in FIG. 5. The aforementioned concept scoring method may be embodied in a semantic page analyzer module 302. The semantic page analyzer 302 gets (601) the content of a page 301 as input. The semantic page analyzer 302 parses (602) the text of the content, indexes the text of the content, obtains (603) the concepts, and concept network. Further, the semantic page analyzer 302 assigns (604) relevancy scores to the concepts. The semantic page analyzer may use the concept relation database 303 to obtain information including but not limited to the number of other concepts a concept is related to, and the weight values assigned for various semantic relationship types. Using the relevancy scores determined for the concepts identified in the content 301, semantic page analyzer 302 generates (605) a list of relevant concepts 304 that may be sorted according to the relevancy score. A ranking module 501 may further rank (606) the input list of relevant concepts using a ranking algorithm. In a preferred embodiment, ranking may be performed according to the ranking methods disclosed by Kalaputapu et al. The ranking module may further use a filter module 502 to filter (607) concepts according to various business rules, as disclosed in the aforementioned application. Ranking module 501 generates (608) a list of concepts 503 that are ranked in a particular order based on the algorithm used and other filtering mechanisms.

In some embodiments, the list of relevant concepts may further be ranked by using a set of business rules in addition to the relevancy scores assigned to the concepts.

In some embodiments, the list of relevant concepts or a subset of such list of relevant concepts, and/or the list of further ranked concepts may be used for highlighting relevant concepts in a page. In one example, highlighting may involve linking relevant concepts to concept database such that the linking enables providing more information about the highlighted concept. When a user visits (for example, by clicking or placing a cursor over) a highlighted concept, the user may be presented with more information relating to the highlighted concept including but not limited to concept definition information, information on related concepts, relevant texts and books information, and commercial ads relating to the concepts among others.

In other embodiments, the list of relevant concepts or a subset of such list of relevant concepts, and/or the list of further ranked concepts may be used to improve contextual analysis for serving relevant ads on a page. For example, top few results from a list of relevant concepts in a page may be used to determine the general topic of the page. Further, information on the general topic may be used to decide on the best advertisements for a page.

In some other embodiments, the list of relevant concepts or a subset of such list of relevant concepts, and/or the list of further ranked concepts may be used for disambiguation of terms in the content of a page. For example, the name “Michael Jackson” refers to different people, a pop singer (http://en.wikipedia.org/wiki/Michael_jackson) or writer http://en.wikipedia.org/wiki/Michael_Jackson_(writer)), among others. Based on the connectivity on a particular page, one concept will be ranked higher than the other after the page analysis. The Michael Jackson concept with the highest ranking is then the true concept. The other Michael Jackson concepts can then be removed.

In some other embodiments, the methods disclosed herein may also be used for suggesting related concepts for a given concept.

Methods and systems disclosed herein allow for use of semantic analysis in concept selection. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method of concept prioritization, said method comprising of
finding at least one concept present in a page;
relating a concept from said at least one concept to other concepts present in said page;
finding number of relationships had by said concept;
determining average weight for relationship of said concept with other concepts; and
determining a relevancy score for said concept.

2. The method, as claimed in claim 1, wherein said page is a web page.

3. The method, as claimed in claim 1, wherein number of relationships had by said concepts is further found using a relational database.

4. The method, as claimed in claim 1, wherein average weight for relationship of said concept with other concepts is determined based on at least one of
weights for each relationship of said concept; and
weights for neighbors of said concept.

5. The method, as claimed in claim 4, wherein said weights for each relationship of said concept and said weights for neighbors of said concept are present in a look up table.

6. The method, as claimed in claim 1, wherein said relevancy score is computed using
r=((C/R)*W)+(D*avg(r(neighbors))),
where
C=Connectivity of K, i.e. the number of concepts on a page to which a concept has a relationship to,
R=total number of relations for K in the relation databases, and
W=weighting of relations for K on basis of their type.
D=constant for weighting neighbor weights, where neighbors are concepts related to a source concept

7. The method, as claimed in claim 1, wherein concepts are further assigned ranks on basis of said relevancy score.

8. The method, as claimed in claim 7, wherein concepts are arranged on basis of said ranks.

9. A semantic page analyzer, said semantic page analyzer comprising at least one means configured for
finding at least one concept present in a page;
relating a concept from said at least one concept to other concepts present in said page;
finding number of relationships had by said concept;
determining average weight for relationship of said concept with other concepts; and
determining a relevancy score for said concept.

10. The semantic page analyzer, as claimed in claim 9, wherein said semantic page analyzer is configured for finding at least one concept in a web page.

11. The semantic page analyzer, as claimed in claim 9, wherein said semantic page analyzer is configured for finding number of relationships had by said concepts using a relational database.

12. The semantic page analyzer, as claimed in claim 9, wherein said semantic page analyzer is configured for determining average weight for relationship of said concept with other concepts based on at least one of
weights for each relationship of said concept; and
weights for neighbors of said concept.

13. The semantic page analyzer, as claimed in claim 12, wherein said semantic page analyzer is configured for looking up said weights for each relationship of said concept and said weights for neighbors of said concept in a look up table.

14. The semantic page analyzer, as claimed in claim 9, wherein said semantic page analyzer is configured for computing said relevancy score using
r=((C/R)*W)+(D*avg(r(neighbors))),
where
C=Connectivity of K, i.e. the number of concepts on a page to which a concept has a relationship to,
R=total number of relations for K in the relation databases, and
W=weighting of relations for K on basis of their type.
D=constant for weighting neighbor weights, where neighbors are concepts related to a source concept

15. The semantic page analyzer, as claimed in claim 9, wherein said semantic page analyzer is configured for assigning ranks concepts on basis of said relevancy score.

16. The semantic page analyzer, as claimed in claim 15, wherein said semantic page analyzer is configured for arranging said concepts on basis of said ranks.
